(19) United States
(12) Patent Application Publication
(10) Pub. No.: US 2026/0200050 A1
(43) Pub. Date: Jul. 16, 2026

(54) POWER RATCHET TOOL

(71) Applicant: Hsu Huan CHIANG, Taichung City (TW)

(72) Inventor: Hsu Huan CHIANG, Taichung City (TW)

(21) Appl. No.: 19/298,296

(22) Filed: Aug. 13, 2025

(30) Foreign Application Priority Data
Jan. 16, 2025 (TW) 114101747

(51) Int. Cl. B25B 21/00

(52) U.S. Cl. CPC B25B 21/004

(57) ABSTRACT

A power ratchet tool has a connection part, a crank shaft, at least one bearing, a ratchet yoke, and a ratchet set. The connection part has a connecting tube and a ratchet casing integrally formed with each other. The ratchet casing has two positioning arms spaced apart from each other and a bridge section connecting peripheries of the two positioning arms. The crank shaft is rotatably disposed in the connecting tube. The at least one bearing is sleeved on the crank shaft, is arranged in the connecting tube, and tightly supports between the connecting tube and the crank shaft. The ratchet yoke and the ratchet set are connected to each other and are arranged in the ratchet casing. The power ratchet tool with a sufficient length and good structural strength can be inserted into a cramped installation space for tightening or loosening fasteners.

### BACKGROUND OF THE INVENTION

### 1. Field of the Invention

The present invention relates to a power tool, and more particularly to a power ratchet tool that can be inserted into a cramped installation space and has good structural strength.

### 2. Description of Related Art

A conventional power tool, used for labor saving, is driven by compressed air or electricity to rotate fasteners such as bolts or nuts in a forward or reverse direction to fasten or loosen the fasteners.

However, the conventional power tool driven by compressed air or electricity usually has a complex driving mechanism and a larger size, which is not suitable to be used in a cramped installation space with parts in a tight arrangement such as an engine bay. In order to be inserted into the cramped installation space to loosen or to fasten the fasteners, the conventional power tool is designed to have a slender appearance.

As shown in FIG. 6, a conventional power ratchet tool 90, configured to be inserted into a cramped installation space, substantially comprises a connection part 91, a ratchet casing 92, a crank shaft 93, a ratchet yoke 94, and a connecting nut 95. The connection part 91 is an elongated tube. The ratchet casing 92 is connected to an end of the connection part 91. The crank shaft 93 is inserted through the connection part 91. The ratchet yoke 94 is connected to the crank shaft 93 and is arranged in the ratchet casing 92. The connecting nut 95 is arranged at the other end of the connection part 91 and is configured to be connected with a transmission mechanism. The conventional power ratchet tool 90 is connected to a cylinder or a motor via the transmission mechanism.

Limited by current manufacturing technology, it is difficult to manufacture a workpiece with both sufficient length and good structural strength in one single piece. As shown in FIG. 6, in order to increase the length of the conventional power ratchet tool 90, the connection part 91 being elongated is connected to the ratchet casing 92 via a threaded connection. The ratchet casing 92 has a mounting opening 921 for inserting the ratchet yoke 94 into the ratchet casing 92. Wherein, the mounting opening 921 almost surrounds an entire periphery of the ratchet casing 92.

However, since the connection part 91 and the ratchet casing 92 are connected to each other via a threaded connection, after long-term use and operation of the conventional power ratchet tool 90, the connection part 91 and the ratchet casing 92 may be loosened and detached from each other due to vibration. Moreover, since the mounting opening 921 almost surrounds the entire periphery of the ratchet casing 92, the ratchet casing 92 is easily broken. In summary, the conventional power ratchet tool needs to be improved.

To overcome the shortcomings, the present invention tends to provide a power ratchet tool to mitigate the aforementioned problems.

### SUMMARY OF THE INVENTION

The main objective of the invention is to provide a power ratchet tool which has a connection part and a ratchet casing integrally formed as a single piece, so that the power ratchet tool may both have a sufficient length and good structural strength.

A power ratchet tool in accordance with the present invention comprises a connecting part, a crank shaft, at least one bearing, a ratchet yoke, and a ratchet set. The connection part comprises a connecting tube having two opposite ends and a ratchet casing integrally formed with one of the two opposite ends of the connecting tube. The ratchet casing comprises two positioning arms extending away from the connecting tube and spaced apart from each other, and a bridge section connecting peripheries of the two positioning arms. The crank shaft is rotatably disposed in the connecting tube. The at least one bearing is sleeved on the crank shaft, is arranged in the connecting tube, and tightly supports between the connecting tube and the crank shaft. The ratchet yoke is swingably disposed in the ratchet casing and between the two positioning arms, and is connected to the crank shaft. The ratchet set is connected to the ratchet yoke and comprises a tool head. Wherein a length of the connection part is greater than or equal to 150 millimeters and less than or equal to 180 millimeters.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a power ratchet tool in accordance with the present invention;

FIG. 2 is an exploded perspective view of the power ratchet tool in FIG. 1;

FIG. 3 is a side view in partial section of the power ratchet tool in FIG. 1;

FIG. 4 is a side view in partial section of a connection part of the power ratchet tool in FIG. 1;

FIG. 5 is an enlarged perspective view of the connection part of the power ratchet tool in FIG. 1; and

FIG. 6 is an exploded perspective view of a conventional power ratchet tool.

### DETAILED DESCRIPTION OF PREFERRED EMBODIMENTS

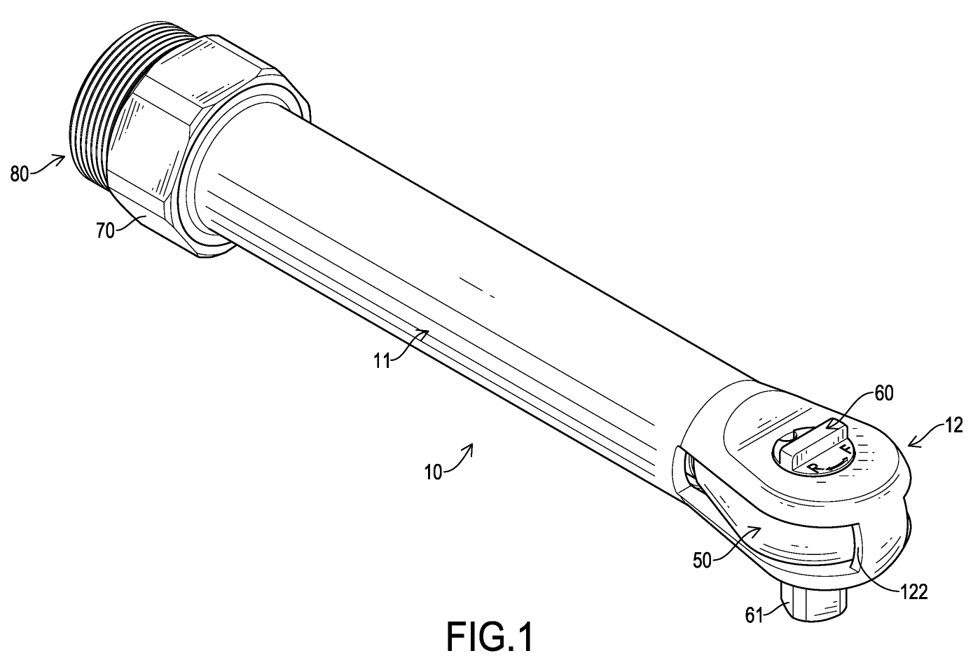

With reference to FIGS. 1 to 4, a power ratchet tool in accordance with the present invention comprises a connection part 10, a crank shaft 20, at least one bearing 30, a ball-shaped bushing 40, a ratchet yoke 50, and a ratchet set 60.

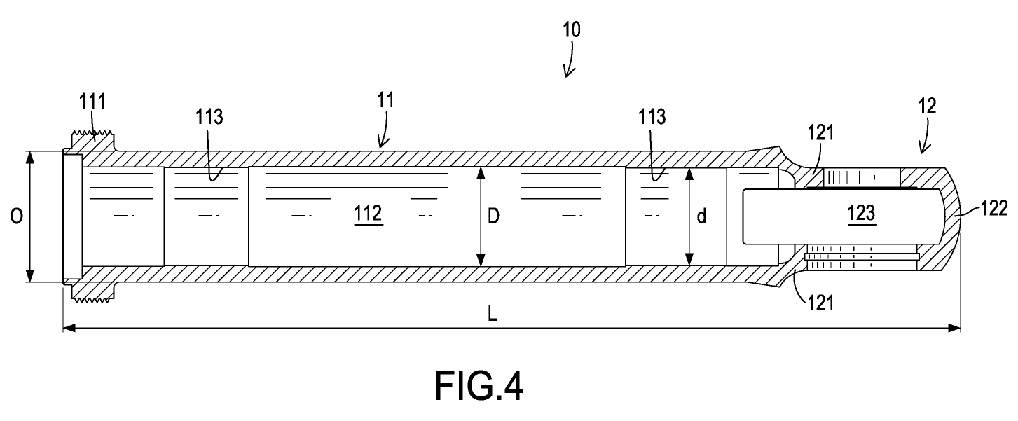

With reference to FIGS. 1 to 4, the connection part 10 is configured to be connected to a driving device for providing power. The connection part 10 comprises a connecting tube 11 and a ratchet casing 12. Wherein, the connecting tube 11 comprises two opposite ends, a connecting section 111, a passage 112, and at least one bearing mounting section 113. The connecting section 111 is arranged at one of the ends of the connecting tube 11 and has a thread spirally surrounding an outer peripheral surface thereof. The connecting section 111 is configured to be connected to a planetary gear set 80 via a connecting nut 70 to connect the driving device. As shown in FIG. 4, the passage 112 is formed in and extends along the connecting tube 11, and has a first inner diameter D. The at least one bearing mounting section 113 is formed in the connecting tube 11 and fluidly communicates with the passage 112. Each of the at least one bearing mounting section 113 has a second inner diameter d being smaller than the first inner diameter D of the passage 112. The at least one bearing mounting section 13 may comprise two bearing mounting sections 113. The two bearing mounting sections 113 are respectively adjacent to the ratchet casing 12 and the connecting section 111. Specifically, the second inner diameter of the bearing mounting section 113 adjacent to the connecting section 111 is slightly larger than the second inner diameter of the bearing mounting section 113 adjacent to the ratchet casing 12, so a plug gauge may be smoothly inserted into the connecting tube 11 elongated in the present invention from the end thereof away from the ratchet casing 12 to measure the second inner diameter of the bearing mounting section 113 adjacent to the ratchet casing 12.

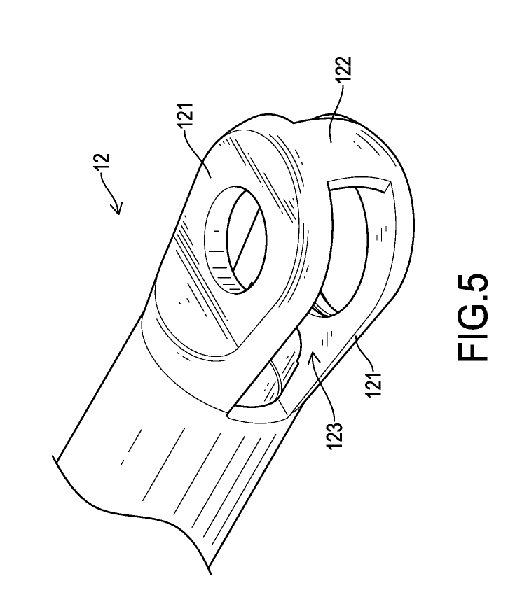

With reference to FIGS. 1 to 4, the ratchet casing 12 is integrally formed at the other end of the connecting tube 11 and is opposite to the connecting section 111. As shown in FIG. 5, the ratchet casing 12 comprises two positioning arms 121 and a bridge section 122. The two positioning arms 121 extend from the connecting tube 11, away from the connecting section 111, and are spaced apart from each other. Each positioning arm 121 has a respective through hole formed therethrough. The bridge section 122 connects peripheries of the two positioning arms 121. Therefore, the ratchet casing 12 comprises two openings 123 respectively formed at opposite two sides of the bridge section 122.

In the embodiment, the bridge section 122 and the connecting tube 11 are opposite to each other. The bridge section 122 and the connecting tube 11 are respectively arranged at two opposite ends of the ratchet casing 12.

As shown in FIG. 4, specifically, under the premise of sufficient length and good structural strength, the connection part 10 has a length L being greater than or equal to 150 millimeters and being less than or equal to 180 millimeters. The connecting tube 11 of the connection part 10 has an outer diameter O being 24 millimeters.

With reference to FIGS. 1 to 4, the crank shaft 20 is configured to transmit power and drive the ratchet yoke 50 to move relative to the ratchet casing 12. The crank shaft 20 is rotatably disposed in the connecting tube 11 of the connection part 10 and comprises a shaft body 21 and a mounting rod 22. The shaft body 21 has two opposite ends. The mounting rod 22 is eccentric to the shaft body 21, is arranged at one of the two ends of the shaft body 21, and is adjacent to the ratchet casing 12.

With reference to FIGS. 1 to 4, the at least one bearing 30 is sleeved on the crank shaft 20, is arranged in the passage 112 of the connecting tube 11, and tightly supports between the connecting tube 11 and the crank shaft 20. The at least one bearing 30 comprises two bearings 30 respectively arranged in the two bearing mounting sections 113 and tightly supporting between the bearing mounting sections 113 and the shaft body 21 of the crank shaft 20 to allow the crank shaft 20 to extend rotatably in the connecting tube 11 of the connection part 10.

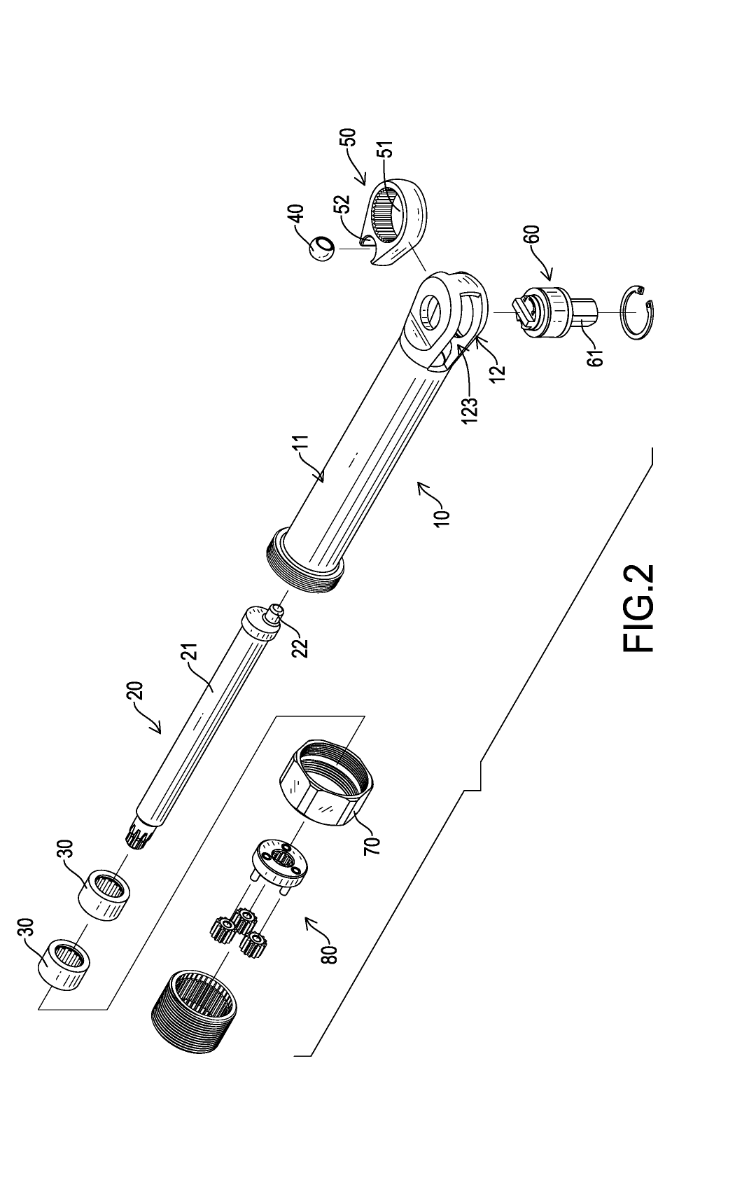

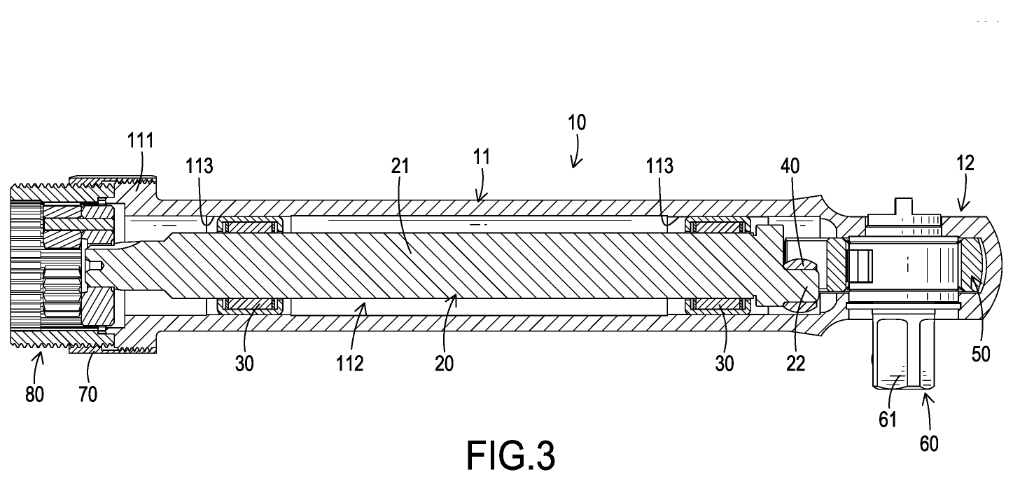

With reference to FIGS. 2 and 3, the ball-shaped bushing 40 is sleeved on the mounting rod 22 of the crank shaft 20. The ball-shaped bushing 40 is conventional, so details thereof are omitted.

With reference to FIGS. 1 to 3, the ratchet yoke 50 is swingably disposed in the ratchet casing 12, between the two positioning arms 121 of the ratchet casing 12, and is connected to the crank shaft 20. The ratchet yoke 50 comprises a through hole 51 and a containing chamber 52. Multiple engaging teeth are arranged around an inner peripheral surface of the through hole 51. The containing chamber 52 receives the ball-shaped bushing 40 to connect the ratchet yoke 50 with the crank shaft 20.

With reference to FIGS. 1 to 3, the ratchet set 60 is connected to the ratchet yoke 50 and comprises a tool head 61 configured for rotating a fastener. The ratchet set 60 engages with the engaging teeth arranged around the inner peripheral surface of the through hole 51 of the ratchet yoke 50 via a ratchet pawl (not shown). Since the connection of the ratchet set 60 and the ratchet yoke 50 is conventional, details thereof are omitted.

With reference to FIGS. 1 to 5, to assemble the power ratchet tool in accordance with the present invention, the two bearings 30 are sleeved on the shaft body 21 of the crank shaft 20, and then the crank shaft 20 and the two bearings 30 thereon are inserted into the connecting tube 11 of the connection part 10 to arrange the two bearings 30 respectively in the two bearing mounting sections 113. Each bearing 30 tightly supports between the connecting tube 11 and the shaft body 21 of the crank shaft 20.

With reference to FIGS. 1 to 5, after that, the ratchet yoke 50 and the ball-shaped bushing 40 are conveniently placed into the ratchet casing 12 via the opening 123 thereof. Then, the ratchet set 60 is mounted in the through hole 51 of the ratchet yoke 50 to complete the assembly.

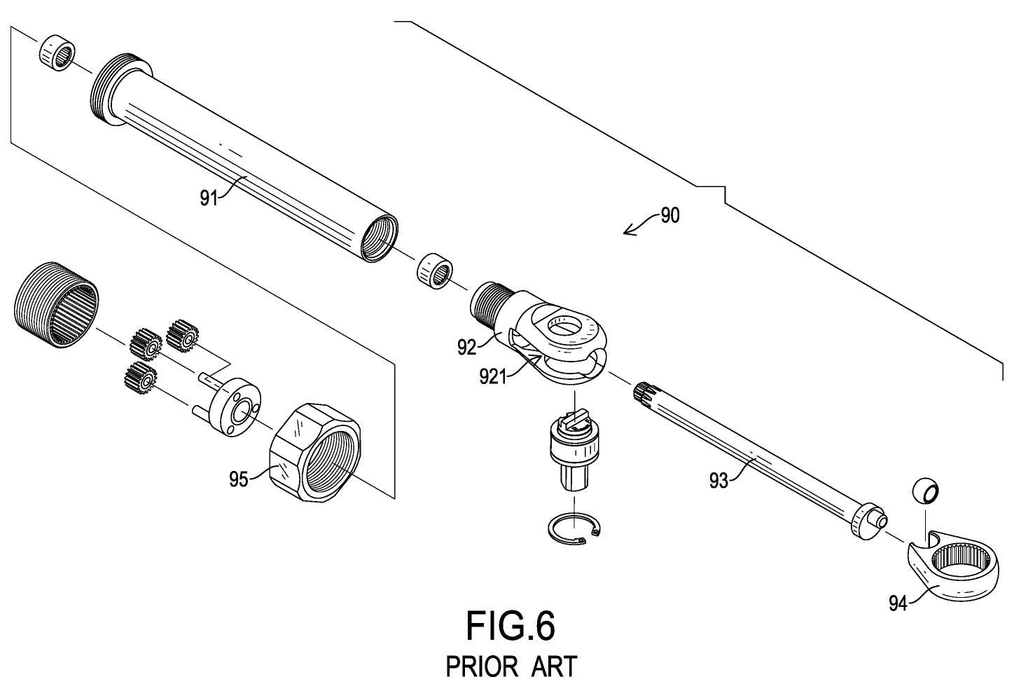

Compared with the conventional power ratchet tool 90 as shown in FIG. 6, which comprises the connection part 91 and the ratchet casing 92 detachably connected to each other, the power ratchet tool in accordance with the present invention comprises the connection part 10, which is formed as one single piece by the connecting tube 11 and the ratchet casing 12 integrally formed with each other. Since the connection part 10 is one single piece, time and labor devoted to the assembly of the connecting tube 11 and ratchet casing 12 are saved. Since the connection part 10 is one single piece, after use over time, the connecting tube 11 and the ratchet casing 12 are free from loosening to detach from each other because of vibration.

Moreover, the ratchet casing 12 of the connection part 10 of the present invention comprises the bridge section 122 for connecting the two positioning arms 121. In the present invention, the bridge section 122 produces the two openings 123 of small sizes. In the conventional ratchet tool 90, shown in FIG. 6, the mounting opening 921 almost surrounds an entire periphery of the ratchet casing 92. Compared with the conventional ratchet tool 90, the bridge section 122 with the two openings 123 opposite to the bridge section 122 in the present invention provides both convenience of assembling and good structural strength of the ratchet casing 12.

In summary, with the structural arrangements of the connecting tube 11 and the ratchet casing 12 integrally formed as one single piece and the ratchet casing 12 having the bridge section 122 for connecting the two positioning arms 121, the power ratchet tool in accordance with the present invention may have both a sufficient length and good structural strength and can be inserted into a cramped installation space with parts in a tight arrangement to bear a high torque when fastening or loosening the fasteners.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A power ratchet tool comprising:
a connection part comprising:
a connecting tube having two opposite ends; and
a ratchet casing integrally formed at one of the two opposite ends of the connecting tube and comprising:
two positioning arms extending away from the connecting tube and spaced apart from each other; and
a bridge section connecting with peripheries of the two positioning arms;
a crank shaft rotatably disposed in the connecting tube;
at least one bearing sleeved on the crank shaft, arranged in the connecting tube, and tightly supporting between the connecting tube and the crank shaft;
a ratchet yoke swingably disposed in the ratchet casing, between the two positioning arms, and connected to the crank shaft; and
a ratchet set connected to the ratchet yoke and comprising a tool head; wherein
a length of the connection part is greater than or equal to 150 millimeters and less than or equal to 180 millimeters.

2. The power ratchet tool as claimed in claim 1, wherein the bridge section and the connecting tube are respectively arranged at two opposite ends of the ratchet casing.

3. The power ratchet tool as claimed in claim 2, wherein
the connecting tube comprises a passage and at least one bearing mounting section;
the passage is formed in and extends along the connecting tube, and has a first inner diameter;
the at least one bearing mounting section is formed in the connecting tube, and each of the at least one bearing mounting section has a second inner diameter being smaller than the first inner diameter of the passage; and
the at least one bearing tightly supports between the at least one bearing mounting section and the crank shaft.

4. The power ratchet tool as claimed in claim 3, wherein the at least one bearing mounting section comprises one said bearing mounting section adjacent to the ratchet casing.

5. The power ratchet tool as claimed in claim 3, wherein the at least one bearing mounting section comprises two said bearing mounting sections respectively adjacent to the two opposite ends of the connecting tube.

6. The power ratchet tool as claimed in claim 1, wherein the connecting tube has an outer diameter being 24 millimeters.

7. The power ratchet tool as claimed in claim 2, wherein the connecting tube has an outer diameter being 24 millimeters.

8. The power ratchet tool as claimed in claim 3, wherein the connecting tube has an outer diameter being 24 millimeters.

9. The power ratchet tool as claimed in claim 4, wherein the connecting tube has an outer diameter being 24 millimeters.

10. The power ratchet tool as claimed in claim 5, wherein the connecting tube has an outer diameter being 24 millimeters.
